(19) United States
(12) Patent Application Publication
(10) Pub. No.: US 2019/0244484 A1
(43) Pub. Date: Aug. 8, 2019

(54) Computer System Providing Decision Support to Sports Oddsmakers

(71) Applicant: Dwayne Alan Nelson, Las Vegas, NV (US)

(72) Inventor: Dwayne Alan Nelson, Las Vegas, NV (US)

(21) Appl. No.: 16/132,391

(22) Filed: Sep. 15, 2018

Related U.S. Application Data
(60) Provisional application No. 62/627,218, filed on Feb. 7, 2018.

(51) Int. Cl. G07F 17/32; G06F 16/903; G06Q 50/34

(52) U.S. Cl. CPC G07F 17/3288; G06Q 50/34; G06F 16/90335

(57) ABSTRACT

The present invention is a computer system that relates to computer systems providing electronic decision support, and more particularly, to the use of a computer device to provide decision support in the area of sporting event oddsmaking. The invention addresses the technical problem of impaired performance in setting and adjusting odds for wagers on sporting events that may arise from imprecision in making associated decisions. The system receives information queries requesting recommendations for odds values and/or adjustments thereto, computes and provides requested information and supporting information, and manages user access and accounts. Information requests, data and query processing, and output transmissions can be conducted in real time prior to the start point of and during a sporting event. In typical implementation, queries from multiple users and on multiple requested information items per user can be handled.

### TECHNICAL FIELD

The present invention relates to computer systems providing electronic decision support, and more particularly, to the use of computer technology to support business operations in the field of sporting event oddsmaking.

### BACKGROUND OF THE INVENTION

A computerized, automated electronic decision support system or EDSS integrates and analyzes data in order to present critical information and recommendations to users who must make complex, often time-sensitive decisions. While EDSSs can simply provide information, the best EDSSs constitute comprehensive business operations management systems. They do so by integrating input information and analyses with the functions required to display apply the information at the time decisions are being made (Kawamoto et al., 2005). When information itself is a key product of the enterprise, EDDSs may perform particularly well, in that their central function is to create actionable information. Intended effects of EDSSs include increased operating efficiency associated with processes requiring decisions and improved associated outcomes, including enhanced profitability and customer satisfaction.

EDSSs are particularly useful in settings in which the total information needed to make an optimal decision exceeds that which an individual person or even a team of individuals can access and/or fully process with the available time and technical resources. EDSSs have gained substantial attention in the healthcare field (Kawamoto, Houlihan & Balas, et al., 2005; Moja, Kwag & Lytras, et al., 2014; Elliott, 2016), where early and widespread use of these systems has occurred as soon as desired features have been permitted by emerging technology. However, EDSSs that employ varying degrees of automation have been researched, developed and implemented in many other sectors. Examples include but are not limited to stock trading (Gottschlich & Hinz, 2014; Boonpeng & Jeatrakul, 2016); manufacturing (Heilal, Montonen & Jarvinen, et al., 2010; Felsberger, Oberegger & Reiner, 2016), particularly automotive manufacturing (Liu, Young & Ding, 2011; Holm, Cordero-Garcia, & Adamson, et al., 2014); and aviation (Zhang, 2011; FAA, 2017).

The sports wagering industry represents a high-stakes field in which EDSSs hold the promise to improve operations and outcomes. Sports betting enterprises in Nevada enjoyed $13.3 billion in revenue in 2016 (Statista, 2018). With the 2018 United States Supreme Court decision that effectively legalized nationwide sports betting, the industry has the potential to reach $150 billion annually in the US (Liptak & Draper, 2018). EDSSs are highly applicable to this sector because of the intensive information-related processes that are the foundation of oddsmaking. “Sportsbooks,” also called “books” or “oddsmakers,” are entities that accept wagers and compute and publish numeric values (“odds” or “lines”) defining payouts to those betting on sporting events. To remain competitive in the evolving sports betting market, oddsmakers must establish and continuously adjust and publish multiple lines each day. This process takes place in a time-sensitive fashion based on a range of information sources and types. Lines must be computed and displayed efficiently in order to attract and maintain “handle,” or the volume of money wagered by the customers, while ensuring profitability for the book.

Overall, in combining large sums at risk, rapid-pace decisions, complex information inputs, and the need for precision, sports oddsmaking is very similar to other sectors in which EDSSs have proven valuable. Sports oddsmaking involves making a decision (what is the published line to be) that is driven by information inputs. To the present day, sportsbooks have dealt with these challenges using proprietary approaches and varying levels of technology. No commercial product has provided a technical solution to this industry in the form of an EDSS.

### BRIEF SUMMARY OF INVENTION

This Summary introduces, in a simplified form, selected concepts that describe and are pertinent to the present invention. These summarized concepts are further described below in the Description of Embodiments. The Summary is not intended to describe all technical features or embodiments of the present invention, nor to limit the scope of its intent or the associated claims.

### Applicability of Invention

Sporting events to which the present invention and the discussion herein pertain are instances in which one or more entities engage in competitive physical and/or mental activity during which the typical goal is to determine relative superiority amongst the competitors, or victory. Entities who may engage in applicable sporting events may include but are not limited to individual persons as well as animals and/or devices that may be controlled by human beings during the event, or that may operate autonomously. Entities may include groups of sub-entities that compete collectively. Altogether, single or grouped entities shall be herein termed “participants” or “teams.” In some sporting events, a single participant may self-compete, such as by attempting to best a prior performance, or may attempt to meet or exceed a defined standard. In applicable events, a terminal status is achieved that reflects success, superiority or victory, or if applicable, a tie or stalemate. The terminal status may be declared as a simple binary state or may be quantitatively reflected in values including but not limited to scores or event completion times. These terminal statuses are outcomes for which betting lines can be devised.

Candidate sporting event types include but are not limited to competitions in baseball; golf; manned and unmanned vehicle or device racing including automotive, motorcycle, watercraft, aircraft and drone racing; horse, dog and other animal racing, including harness racing or other racing in which an animal pulls or propels a vehicle; American football; soccer; basketball; ice and field hockey; boxing; mixed martial arts; track and field; and Olympic events. Other competitions that apply as sporting events for the purpose of the present invention may mainly or entirely involve mental effort rather than physical exertion, such as chess and electronic games. Championships occurring as summative events for sports seasons, or championship series and subcomponents thereof, in which a victor or top-ranked entity might be declared and which are assigned odds, constitute eligible sporting events.

### Technical Problem

The technical problem addressed by the present invention is the substantial complexity, effort and resources involved in managing information and producing optimal outcomes in typical sportsbook operations. Desired goals include but are not limited to enhancing profitability for the book and ensuring positive experiences for customers and their return business. These potentially-competing objectives depend on creating optimized lines for each sporting event. To accomplish these goals, oddsmakers must reliably process substantial data inputs under serious time constraints, as the temporal window in which most bets are made and the most useful information required to compute lines is available is altogether often short.

Intensive study of sportsbook business data suggests that these entities engage in a classifiable range of business strategies when dealing with these inputs. In turn, these identifiable tactics are amenable to being condensed into algorithmic processes in an EDSS, reducing the mental activity a book's staff might need to invest to produce the desired result. For example, a common, conservative approach to oddsmaking mainly focuses on tightly positioning lines relative to handle and market pricing to protect the bottom line, almost irrespective of the objective chances of a win by a given participant. A more progressive approach may attempt to produce “looser” lines that attract more handle at some risk to profits. Books may wish to adjust lines more or less frequently to maximize profit and/or to stay competitive with the lines of other books. Managing the large information volume associated with any selected approach inevitably results in some level of imprecision and variability in sportsbook performance, whether measured in terms of profits and/or the customer experience.

In this complex milieu, what is needed is a customizable, precise method for line setting and adjustment, one that draws on the proven methods in the production of EDSSs in other spaces. An opportunity therefore exists to increase total book performance and to potentially reduce performance variation by introducing greater precision at the point of decision-making on price.

### Solution Provided by the Invention

Analyzing sportsbook business data demonstrates that a plurality of computational methods, when integrated into a single system, can provide user-tailored information that matches an oddsmaker's chosen business strategy. An EDSS that incorporates such functions and provides real-time information output supporting a plurality of possible business operation philosophies will allow a sportsbook to enhance performance while remaining competitive in terms of published price. The solution to the technical problem is therefore an automated system that processes data inputs and produces publishable lines within user-specified parameters.

The present invention is thus a computer system that serves as an EDSS be integrating the information functions involved in sports line setting: accepting and managing data inputs; processing data based on user specifications; and displaying outputs to users with, depending on implementation, efficient display of lines to the wagering customer base. To accomplish these functions, the present invention consists of a computer; a database; and a customizable logic that combines automated and user-directed parameters to produce live betting lines. The present invention supports activity by a plurality of users, manages user accounts, and provides responsive output in the form of sports line recommendations that may be displayed to customers as final lines, if user-approved. Multiple real-time data inputs are automatically analyzed by the system to produce the odds recommendations. Output may involve one or more user-selected sporting event participants and distinct sporting events.

### Advantageous Effect of Invention

The advantageous effect of the computer system is to efficiently process data and enhance information flow, reducing sportsbook workload while increasing operational efficiency and performance. The automated process increases efficiency because its computer-based approach can handle data that, depending on the implementation, may exceed that which a human oddsmaking team can effectively process using historical methods. The result is a more accurate and rapid response to marketplace conditions in instances where consulting multiple information sources is inconvenient or impossible, particularly due to available time. The system may permit reduced manpower allocation to the oddsmaking enterprise, reducing associated operating costs.

### BRIEF DESCRIPTION OF DRAWINGS

FIG. 1 demonstrates the components of a computer.

FIG. 2 illustrates the environment of an example implementation of the computer system.

FIG. 3 presents the organization of an example database supporting the computer system.

FIG. 4 lists the major processes that are implemented by the computer system.

FIG. 5 displays an example of processes that occur to establish a valid query to the computer system.

FIG. 6 displays an example of processes conducted by the computer system to access and handle data.

FIG. 7 demonstrates and example of processes conducted by the computer system to process and convey data.

FIG. 8 displays an example of processes involved in termination of a session using the computer system.

### DESCRIPTION OF EMBODIMENTS

The present invention comprises a computer system that accepts data inputs, processes data and provides real-time access to the products of data processing at any time point relative to an associated sporting event. In all embodiments or implementations, the system conducts at least basic user account management functions such as user access verification; receives queries from at least one user requesting recommendation information on the betting line for at least one sporting event participant; accesses data relevant to sporting events and sports betting lines; manipulates such data so as to produce output information that satisfies a user query; and reports output information to satisfy a query in a manner that is customized per a user's preferences, to include transmission of line data to other systems in which the information is made available to customers.

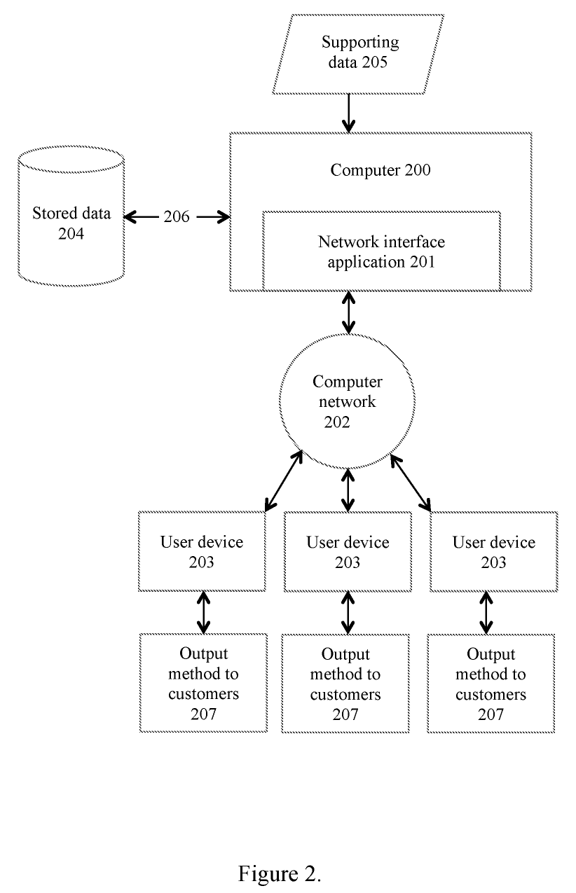

“Users” herein are entities identified as authorized for and who may engage in “sessions,” or instances of use of the computer system. Users may constitute individual persons, or may be commercial entities and representatives thereof. Users are typically agents of sportsbooks engaged in sports line setting and adjustment. In some implementations, users' sessions may occur partially or entirely via automated means, rather than through direct action by a person. In an implementation involving a computer network connection, users may connect to the computer system using devices that each also typically constitute a form of computer device, as defined in FIG. 2 and discussed in material associated with it. “Customers” are the individuals accessing the final betting line data published by sportsbooks as part of decisions about wagering activity.

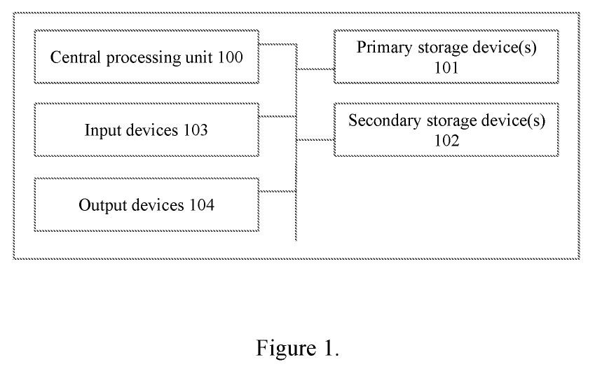

The system includes one or more discrete computer devices, such as that depicted in FIG. 1 and discussed herein. An applicable computer connects to or incorporates a database containing relevant information to the determination of the queried information output. The system employs these data inputs to conduct computations in order to determine the recommendations for sports betting line values based on a default algorithm or user-directed parameters. In certain implementations, the system connects to one or more computer networks via network interfaces to permit queries from a plurality of users and, if dictated by the implementation, by customers. In other implementations, the system serves as a standalone computing device that is directly accessed by one or more users.

The computer system has the capacity to access, maintain and analyze data on users and their usage instances. Data captured by the system regarding sporting events, and information on associated user queries that preceded or occurred during sporting events, will constitute data inputs that may be accessed in support of computations associated with later queries by the same or other users.

Referring now to FIG. 1, the components that define a computer will be described. A computer includes hardware (tangible mechanical and electronic devices) and associated programs (effectively intangible data and instruction sets installed on hardware for the purpose of managing information) that altogether provide the capability to execute required operations. Computers herein are considered any device that includes hardware components that accomplish these functions. FIG. 2 displays the hardware components that constitute a computer.

The components depicted in FIG. 1 are connected as part of an electrical circuit such as a “BUS network.” The components may be jointly installed onto a platform such as a “motherboard” that facilitates electrical connections between components and provides them physical support and stability. Computer components may be contained in a single physical housing when mounted on a cot non platform such as a motherboard, but collocation of the computer's components within a single housing or at a single location is not a requirement defining a computer. Depending upon the implementation, the components may be connected by means other than a motherboard to enable a functional circuit, such as cables between units separately housing components.

Referring to FIG. 2, the components of a computer will include at least one central processor 100. A central processor typically includes a control element and a datapath element. A central processor 100 carries out the main computational workload of a computer, such as performing key determinations and calculations to be described in subsequent Figures and their associated discussion.

A computer will include one or more primary storage devices 101, also known as internal memory. The primary storage 101 holds limited data volumes for rapid access during computational processing, and enables basic functions necessary to activate and maintain the functional status of the computer. Examples of primary storage devices include but are not limited to random access memory and read only memory.

A computer will typically include one or more secondary storage devices 102, also known as backing memory storage. The secondary storage 102 provides long-term data storage when data must be retained beyond a single usage session. Secondary storage may be removable or non-removable, and may be portable or fixed in a single location. Examples of secondary storage include but are not limited to internal and external hard drives, but also include “memory sticks.” Some data that may be accessed by the computer during its operations may reside in storage devices that are not part of its integral secondary storage 102, such as data available from Internet sources, data kept in “cloud” storage, or data retained in other remote locations.

The secondary storage 102 of the computer will house all or most software supporting the computer system's primary operations as an EDSS. However, some such software may be found in the primary storage 101 in certain configurations. Critical software for a computer include the operating system, which provides master control of most software applications installed in the computer's data storage.

A computer will also include devices that enable data input 103 and output 104. Input devices include but are not limited to scanners, keyboards, “mice,” and natural user interfaces that collect data from user speech, movement or other user activity. Output devices include but are not limited to monitors, speakers, printers, and may be construed to include associated hardware that enable their use, such as graphic cards. Software enabling the conversion of computational products to perceptible information will be termed an “output conversion application” in discussion below. Because of the wide variety of methods by which data may be accessed by and transmitted by the computer system, input and output devices and methods will be addressed further in multiple sections to follow.

FIG. 2 displays an example implementation of the computer system, which will now be described.

Referring to FIG. 2, in one implementation of the computer system, a network interface application 201 connects a computer 200 to a computer network 202. A computer 200 is defined for this invention as possessing the technical components depicted in FIG. 1 and described in its associated discussion. A computer 200 may be represented by a variety of computing device types, including but not limited to a “server” computer (a single, high-capacity machine designed to support numerous users), a “virtual server” (a high-capacity computing environment that functions as a server but can exists across multiple physical computer devices), or a “workstation” computer (a machine of medium-to-high capacity often associated with a single user at a time).

In this embodiment, one or a plurality of users initiate a session in which they employ devices 203 to connect to the network 202, permitting the inputting of queries that are processed by the computer 200. The connection process and the query may be manually conducted, or may be automated. Three user devices 203 have been depicted in FIG. 1 solely for the purpose of illustrating the potential plurality of users; the actual number of users is limited only by the implementation. Machines constituting a user device 203 may include but are not limited to server computers, workstation computers, desktop computers, laptop computers and mobile devices such as digital notepads and smart phones.

Any information constituting parameters of, describing or arising from user queries, including but not limited to directly inputted data or automatically-derived information about the session, such as dates, times, locations, durations and details of queries or attempts at inputting queries, may constitute supporting data 205 and may be retained as stored data 204, depending upon the implementation of the system. To support the computations conducted by the server computer 200, data 205 that are obtained anew from user inputs or from separate data sources and/or data 204 that are recalled from prior storage are accessed, automatically or at the direction of users or system managers. Such data access may occur at any time relative to sporting events to which data relate. Data inputs 205 are subject to persistent retention in data storage 204 as required for particular embodiments.

Data 205 may be received from one or more sources via routes including but not limited to direct input by system support staff and/or automated extracts. Data 205 may be input by connecting to the Internet or external data sources or repositories using the network interface application 201, or through other input devices such as those described in FIG. 2 and discussed in material associated with it.

Depending upon the implementation of the computer system, the storage repository for data 204 might be accessed to support computer system operations via multiple possible connection methods 206. These methods include but are not limited to use of an application programming interface or API that uses the network application 201 if the data flow requires accessing another computer device that is the physical site of data storage, such as in “cloud”-based data hosting; and/or direct connection to internal and/or external memory devices using input/output devices depicted in FIG. 1 and described in associated discussion.

In typical implementations, use of the computer system will result in conveying information to the user to satisfy the query using text and/or graphic images. Such output may arise from processing by an output conversion application of the computer system itself (for definitions of such applications, see FIG. 1 and associated discussion) or an API to produce the final information form that can be perceived by the user. Alternatively, the output may arise from an output conversion application of the user device 203 as based on digital information transmitted from the computer system.

In typical implementation of the computer system, users are human beings who directly engage in the query process. The user will publish the line information arising from using the computer system to the customers via manual or automated methods in order to inform customers seeking to place wagers. This conveyance of information 207 may occur through a plurality of methods, including but not limited to printed media; manual or automated entry into or transmission of line data to a dedicated website or other mobile information technology application managed or otherwise employed by the user and accessed by customers; and/or direct integration of the computer system with a separate system via an API or other process that organizes and displays such data to customers, whether or not the implementation is associated with wagering functions installed into the computer system itself.

In other implementations, the computer system can be accessed by separate devices that query the system on behalf of an authorized user in an indirect manner, and that manage information exchange in an automated fashion. Examples of such implementations include when a third party uses the outputs as information inputs to support sports betting-related business operations rather than to inform wagers, or when an automated quality control system is employed. In these indirect access implementations, human beings will engage in varying degrees and frequencies of direct access to and involvement with the computer system and its output. In such cases, the computer system's output may be handled solely by automated functions rather than provided in a graphic format. The outputs exist as digital information in such cases, and the graphic display of input and output information to a human user user may be intermittent or may be entirely unnecessary.

The prior discussion has described general features associated with implementations of the computer system. There are multiple possible computer environment-related implementations of the computer system that will vary depending upon the nature of its deployment. Examples of these possible implementations will now be described.

For example, referring again to FIG. 2, a computer 200 may be connected to a public network such as the Internet, and will receive queries from any approved user who is able to connect to the same public network from his or her device.

Alternatively, computer 200 may be part of a private local area network and accessed only by user devices deployed within the network, or that are approved for use on the network using connection technology that permits connection to the network.

In another example, remote viewing of the computer system's output may occur using technology that permits the user device to view or print images created entirely by the hardware and software of the computer system, including but not limited to “remote desktop” functions.

As another example, all use of the computer system can occur via the user's direct interaction with the computer system using local input/output devices, such that access from a separate location via an interface application 201 or network 202 or other connection to external environments is not necessarily needed to support query input and associated output to the user. In this embodiment, the computer system may operate as a standalone device that need not connect to other devices to process a query. However, in such an implementation, the computer system may still possess the capacity to connect to other devices for purposes of acquiring data, system updates and communication of lines to customers. Examples of machine types that may be employed in this embodiment include but are not limited to workstation computers, desktop computers, laptop computers and mobile devices that possess the essential features of a computer demonstrated in FIG. 1 and described in its associated discussion, such as digital notepads and smart phones.

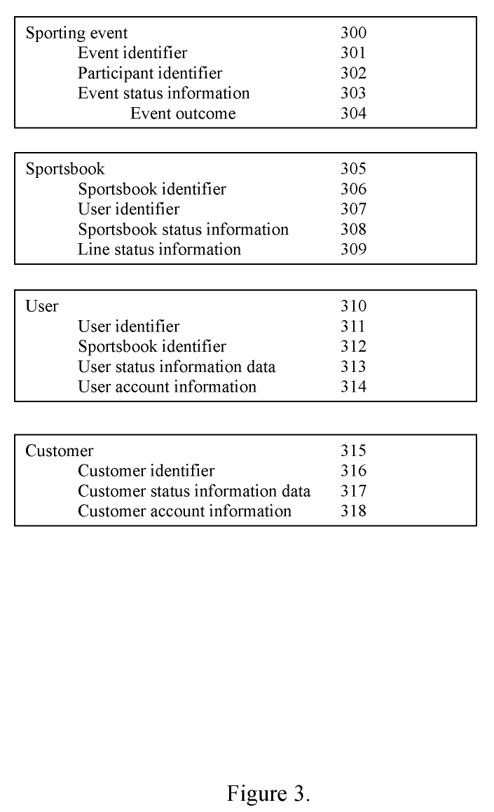

FIG. 3 displays the example composition of a database that is accessed and employed by the computer system, which will now be described. FIG. 3 is not intended to convey all data types that may contribute to or arise from the processing conducted by the computer system, but provides examples of information known to apply to most embodiments.

Referring to FIG. 3, the computer system stores, accesses and computationally employs information related to sporting events and lines, including but not limited to data on sporting events 300, sportsbooks 305, users 311 of the computer system who may be distinct individuals acting as agents of sportsbooks 305, and, if applicable, customers 315 who receive the final output of the system.

Data in FIG. 3 are collectively referred to here as a “database” in terms of constituting a body of information that provides candidate elements that might support computations carried out by the computer system under specified logic rules. It is a body in terms of its utility to the computer system, not necessarily in terms of its organization or location. A database is accessible to the computer system without the requirement that all data contained therein must be stored in a memory device that is physically integral to the computer system, nor that such data must all be stored within the same device or at the same physical location. Some data regularly or potentially supporting computer system operations may reside in repositories that are located outside of the computer system, for access only when intermittently needed. References herein to a database therefore do not imply that all data employed by the computer system and that altogether constitute its database reside exclusively within its constituent devices. Overall, the shared utility of these data to the logic of the system, rather than the location of the digital information, define their role as a database.

A database is also defined herein without the requirement that all data exist as persistent or organized structures such as tables, or in any particular storage format. In some implementations, database components may exist partially or entirely in unstructured formats, meaning not organized to facilitate any particular computational function. Such data may assume organized forms only transiently as a part of computer processing that temporarily aggregates un- or semi-structured data, such as by using common variables to link disparate data types and/or data sources together in a relational fashion, only at the time of the computation. In such processing, the organized form is never perceived by a human user, but merely serves to support the logic of the present invention.

Referring to FIG. 3, the computer system has the capacity to store, access and employ sporting event data 300 on events that have been completed, are ongoing or constitute future events relative to the time of a computation or user query, potentially supporting retrospective, current or prospective analyses. Data on sporting events 300 include but are not limited to identifiers for sporting events 301, identifiers for sporting event participants 302 such as sports teams, and event status information 303. Event status information 303 may include information on the time and date if the event and whether it is delayed or postponed. Data 303 may include any natural, environmental, quantitative or descriptive factors that are pertinent to a sporting event, including weather conditions. Data 303 include the terminal outcomes of completed sporting events 304. Sporting event subcomponents, such as quarters of a football game, may be considered discrete events for which there are dedicated event outcome data 304.

Data on sportsbooks 305 include but are not limited to identifiers for sportsbooks 306, as well as identifiers for users associated with each sportsbook 307. Depending on availability and the implementation of the computer system, further status information on sportsbooks 308 to support the calculations of the computer system is stored in a database, to include but not limited to sportsbook characteristics, “handle” (betting volume and distribution amongst event participants), and line performance data. Sportsbook status data 308 may include any other factors associated with or pertaining to sportsbooks. Information on the lines published by sportsbooks 309 at a plurality of past and present times may be stored or accessed. Line status data 309 may include any factors associated with or pertaining to sports betting lines.

Data on computer system users 310 include individual user identifiers 311 and the sportsbook with which the user is affiliated 312, if applicable. User status data 313 comprise traits of users beyond the identifier value, such as demographics, locations and any other factors associated with or pertaining to users. Further applicable data 313 include but are not limited to metadata describing users' interactions with the computer system, such as timing, frequency, duration and nature of use. Data pertaining to user accounts 314 including contact information and, if applicable for a given implementation, payment information for services, comprising information that is maintained to support account management functions. User account data 314 may include any other factors associated with or needed to manage user access and accounts.

In certain implementations, the computer system will receive and employ data on customers 315 who receive the final outputs specified by users. Data on customers 315 include customer identifiers 316 and customer status information 317. Customer status data 317 comprise traits of customers beyond basic identifying information, such as demographics, locations of activity and the services the customer used. Customer status data 317 may include any other factors associated with or pertaining to customers, including but not limited to data describing customers' use of the computer system or the system(s) with which it interfaces, such as timing, frequency, duration and nature of use. If applicable, data pertaining to customer accounts 318 including contact information and, if applicable for an implementation, payment information, comprising information that is maintained to support account management functions. Customer account data 318 may include any other factors associated with or needed to manage customer access and accounts.

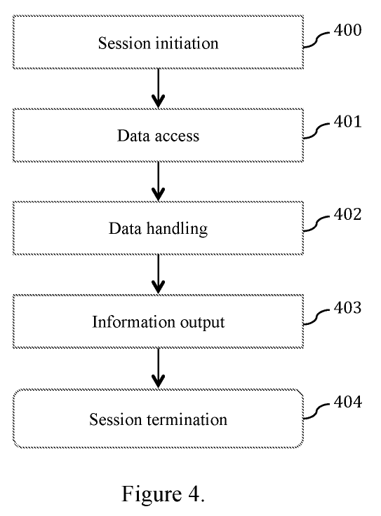

FIG. 4 lists an example of major processes conducted in association with a user session and its associated query/ies to the computer system, and will now be described. FIG. 4 is intended to provide a broad overview of the major processes in an example implementation, and is not intended to explain nor to limit their full scope and detail of these major processes and/or their potential interactions, some of which will be described in further detail in subsequent sections of this patent application.

Referring to FIG. 4, a session is initiated 400 via a method described below, to include manual and automated processes. In certain implementations, the session is initiated by the customer rather than the user because the user's involvement is effectively automated per the user's prior specifications, effectively providing prior approval for system activity. In such cases, the user has previously defined query specifications such that line data are prepared for customer perusal solely on demand; such data are previously prepared and await display only upon customer request. In some implementations, a user session is construed to simultaneously occur with any customer query because the customer must go through a user-managed system to gain access.

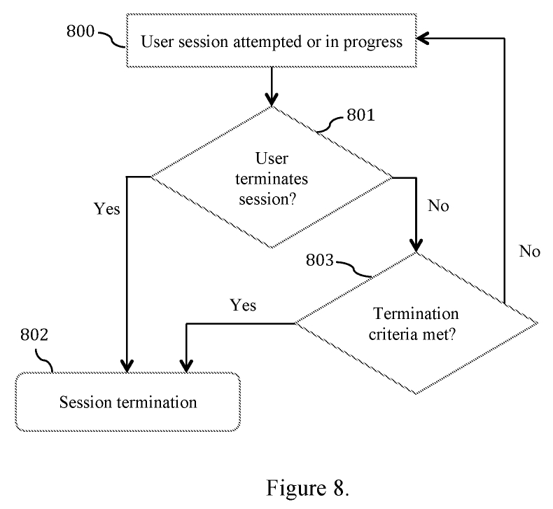

With a session initiated, the computer system then initiates access to data 401 that are appropriate to support the query. Pertinent data may include but are not limited to any items described in FIG. 3. The system handles the data 402 in a manner sufficient to produce output that answers the query. The system then provides information 403 using an output method described herein, to include conveying information to one or more users and/or customers. Whether by user or customer direction or termination by the computer system, the session is terminated 404. See FIG. 8 and its associated description below for more discussion on session termination.

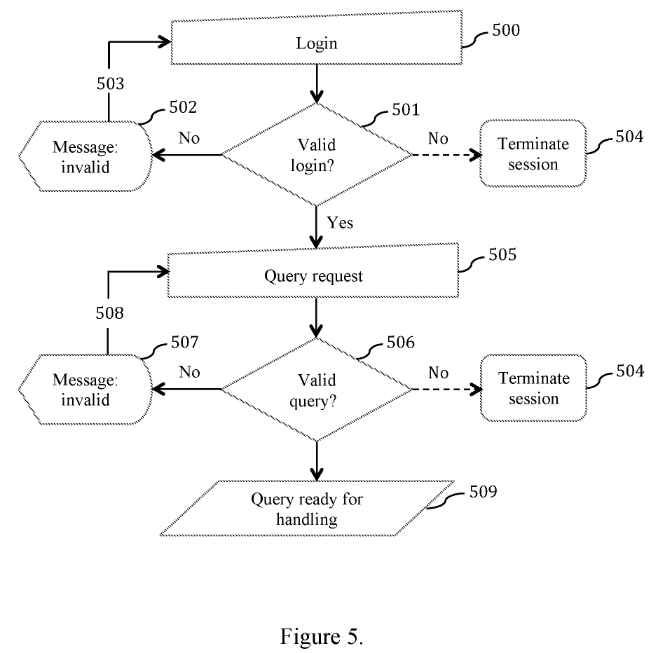

FIG. 5 provides greater detail on session initiation 400 as listed in FIG. 4. Referring to FIG. 5, a user and/or a customer operates an input device to initiate access 500 to the computer system for the purpose of creating a query. An initial determination is made 501 regarding whether the user and/or customer is authorized to access the computer system based on the information entered. Customer and/or user validity may be determined by a number of criteria, including those based on user and customer data described in FIG. 3. Depending on the implementation, these criteria include whether the name and/or password as entered correspond to a valid customer and/or user, and/or the payment status of the relevant account(s). The system possesses the ability to contact users and/or customers via approved methods. New customers and/or users meeting system access criteria may establish an account at this phase of access 500, permitting current and future access to the computer system. In some implementations, temporary guest access may be authorized.

If a customer and/or user is found to be invalid, depending upon the implementation, the computer system may take no action beyond permitting the re-entry of login information 500, thereby passively indicating no valid login has occurred. In other implementations, the computer system may actively return an indicator or message 502 indicating the invalid login status. The system may retain information regarding an invalid access attempt as metadata that become a part of the database.

After an invalid attempt at establishing a valid login, the customer and/or user may re-attempt to access the system 503 after correcting an entry error or other deficiency that created the invalid login state. If the customer and/or user fails to establish login validity after a permitted number of attempts, the customer and/or user may cease further attempts to enter information and terminate the session 504 or, depending upon the implementation, the computer system may terminate the session based on a number of access attempts or a period of user inactivity. See FIG. 8 and its associated description below for more discussion on session termination.

Upon the customer and/or user's entry of information sufficient to establish a valid login, the query request 505 will occur via an automated or manual process. In an automated process, prior user and/or customer specifications will dictate the query parameters. In a manual process, the customer and/or user will enter information using an input device in order to define the parameters of the query. Automated and manual processes are not mutually exclusive, in that automated processes may be predefined, augmented, authorized and/or selected by user manual activity.

The validity of the query is determined 506 by the computer system based on a variety of factors, including but not limited to whether the form and content of the query is consistent with any known or possible data and/or computation. If a query is found to be invalid, depending upon the implementation, the computer system may take no action beyond permitting the entry of the query 505, thereby passively indicating no valid query has been entered. In other implementations, the computer system may actively return an indicator or message to the customer and/or user 507 indicating the invalid status. The system may retain information regarding an invalid query attempt as a part of its database.

The customer and/or user may re-attempt the query 508 after correcting an entry error or other deficiency that created the invalid query state. If no valid query is entered, the customer and/or user may cease further attempts to enter the query and terminate the session 504. Or, depending upon the implementation, the computer system may terminate the session 504 based on a number of query attempts or a period of inactivity. See FIG. 8 and its associated description below for more discussion on session termination.

Upon the determination that a valid customer and/or user has entered a valid query, a complete query has been established 509. The package of information that the query seeks is prepared and committed to output as described in FIG. 4.

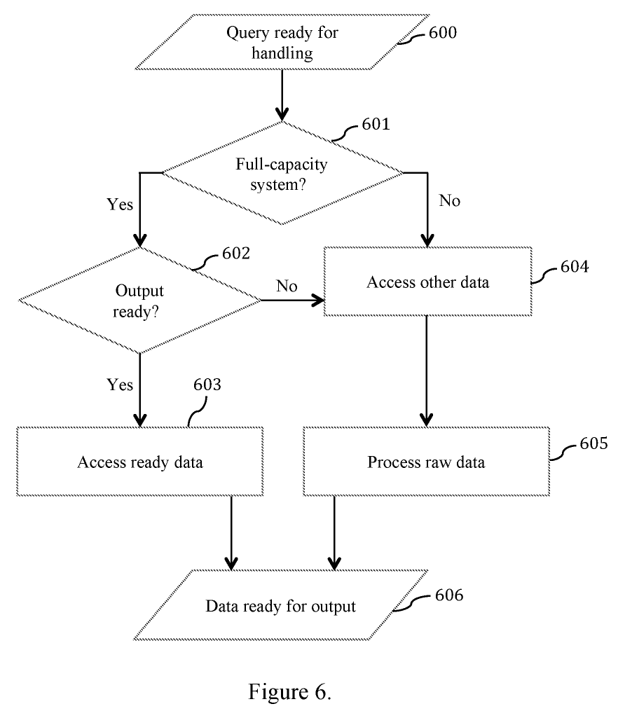

Referring to FIG. 6, query processing after establishment of a valid query 600 involves enabling access to and handling the data required to answer the query. The method of data access and handling is based on the nature of the query and the technical capacity of the system 601 in a given implementation. Suitability to answer a query is determined by the computer system based upon the stored form and content of the data. Data may meet such criteria per its original form when first accessed by the computer system, or data may have previously been organized into and stored in a state sufficient for display. In some implementations, the computer system may be capable of making the determination of the presence of displayable data as early as the query verification step of the overall computer system access process (see FIG. 4 and its associated discussion).

Certain implementations of the computer system (a “full-capacity implementation” referenced in subsequent discussion) will have the capacity to store, to access and to determine the presence of data in an available database that meets the query's specifications by virtue of its form and content when accessed by the computer system.

In a full-capacity implementation, the computer system will determine 602 whether any data are available that, in form and content, already meet at least some of the specifications of the query. If any data are present in a database to satisfy all or part of the query, these data are accessed by the system 603. Alternatively, some or all output to satisfy a given query may need to be processed anew from “raw” data. In the context of the present invention, raw data constitutes information that exists in a form that requires computational processing to attain a further form that is usable to satisfy a query. If such raw data must be used to satisfy the query in a full-capacity implementation, but applicable raw data are available in a database, these data are accessed 604. The data are processed by the computer system 605 to produce data possessing form and content suitable for display in response to the query.

In other implementations, the computer system lacks the capacity to store, access and/or verify the presence of data that require no substantive processing before its display as output (a “partial-capacity implementation” referenced in subsequent discussion). In a partial-capacity implementation, all output is based on processing data that is accessed in a form insufficient to answer a query. A partial-capacity implementation may be implemented for reasons including but not limited to data security concerns or technical limitations, such as limited available data storage capacity or slow connection speeds that limit data movement.

Referring to FIG. 6, in the case of a partial-capacity system, access to required data is enabled 604 to support computational processing in cases where such data are available. The data are processed by the computer system 605 to produce data possessing form and content suitable for display in response to the query.

Upon the completion of accessing ready data or processing data, the resulting package of organized data 606 are ready for transmission to an output conversion application installed in the computer system, or to a device with its own output conversion application, for final conversion into a format that can be perceived and utilized by a user.

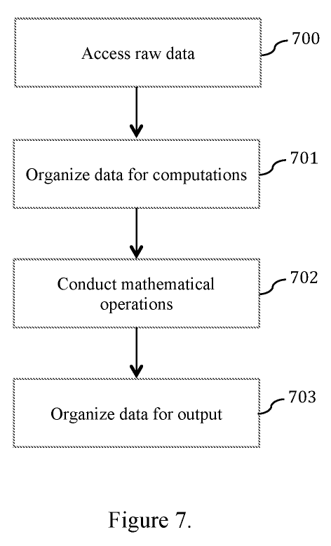

FIG. 7 displays details of process 605 of FIG. 6. Referring now to FIG. 7, the computer system accesses data 700 that are not sufficient in form and/or content to answer a query, either due to the non-availability of appropriate stored data to answer a user query in a full-capacity implementation, or as the default process in a partial-capacity implementation. The computer system organizes data 701 into a format such as a table that will support mathematical operations. In some implementations, the organized format exists only transiently as the computer system temporarily aggregates un- or semi-structured data using common variables to tie disparate databases, data types and/or data sources together at the time of the computation. In other implementations, data are organized into structures that may be retained for a variable period, including for persistent storage in a database. In such implementations, stored data structures may be re-accessed to support further queries by the same or other users, relieving the need to again organize data 701 as part of subsequent data handling.

The system applies mathematical operations 702 to determine line-related output information that is consistent with the central request(s) of and complies with any constraints associated with the query. A typical goal of applicable computational effort is to determine optimal sports line information for the line type, sporting event and participant identified by the user. A line value determined by such computational processing constitutes a recommendation, being a projection or prediction of the value most likely to result in optimum performance, were such a value adopted by a sportsbook as a published line. A single such projected line (such as for a single sports team) or a plurality of such lines (such as for all games to be played on a given day) may be computed as part of the user's session.

Computation 702 producing such line information may be guided by default parameters entered by computer system managers to cover parameter choices that users may not elect to specify in a query, by the specified parameters of a query, and/or by parameters stored as enduring query preferences, altogether which will dictate the type of mathematical operation required to produce output and the form of the line information provided. Depending on the total parameters pertaining to query processing, applicable mathematical operations that may be employed to determine the line projection include regression models, machine learning algorithms, and/or other operations that quantify the relationships between factors with proven or suspected value in predicting optimal lines (predictive factors) and the sports betting lines that might be deployed by sports oddsmakers (the mathematical outcome or objective of the computation).

There are multiple possible query specifications that may guide the computation. For example, the user may specify a request for an absolute line value to which a current line might be adjusted, leading to hypothetical computation of a value such as “−112”. Alternatively, the user may want to see a value that constitutes recommended change to an existing line, prompting computations that hypothetically suggest to numerically decrease the current line of “−110” by a quantity of 2, also resulting in a value of “−112.” The user may request information with or without regard for the sports wager lines published in the market at the time of the query. Requested output may specify how the current money line at sportsbook A can be optimized for sports team X when considering current and projected line values at competing sportsbooks B and C. The resulting computation may determine that this line could be changed to “−120” from its current value of “−110” or, equivalently, that it could be numerically reduced by 10 points, yet still remain very competitive with the market. Either mathematical version of the recommendation may be specified and produced by the computer system.

Alternatively, the user may more specifically dictate that a computed line value hold a particular mathematical value defined by relativity to other values. Relativity may represent a quantity specified by the user or a value that is computed to be optimal with respect to the market's line range. As a hypothetical example, the line for sports team X at the time of the query at sportsbook A is “−110;” at sportsbook B, the line is “−120;” and at sportsbook C, the line is “−115.” The sportsbook A user may direct that a line adjustment be computed that will represent the lowest value at least 2 points higher than the lowest numeric line value among the competition. The resulting computation 702 may determine that sportsbook A′s line be changed to “−118” from its current value of “−110.”

To convert computed information to usable output, the system organizes data 703 into a format that contains the essential data elements required to satisfy the query. The output production process may include reduction of tables or other data structures into subsets or into single data elements, such as an absolute line value or a quantity and vector for the adjustment to an existing line value. Data organization 703 may include packaging computed lines with supporting data. In many implementations, supporting data are needed that may include identifiers for sporting event competitors, trend data for comparative lines from one or more sportsbooks, and/or past recommendations by the system. Such information may be computed as a part of process 703 in order to enhance the user and/or customer experience.

FIG. 8 demonstrates greater detail regarding the computer processing involved in termination of a user session, as originally referenced in process 404 of FIG. 4, and will now be described. Referring to FIG. 8, a user session has been attempted or is in progress 800. At any time during the attempt or session, the user may elect 801 to terminate the attempt or session 802 using inputs to an input device. As a response 803 to termination criteria that may include but are not limited to a defined number of invalid entries by the user as part of a session log-in attempt, a period of user inactivity, administrative reasons, technical problems or responses thereto, the computer may terminate the session 802. In the absence of user or computer system action to terminate the session, the session continues 800. Upon termination of a session 802, the user is eligible to re-initiate access to the computer system, provided that a valid user access status and the technical means for re-establishing a connection to the computer system exist.

What is claimed:

1. A computer system, comprising: a computer, consisting of a processor device and primary memory device connected to the processor device, altogether capable of accessing data stored in secondary memory and/or data sources that are stored in other computer devices; and secondary memory connected to the processor and/or primary memory; and an interface application installed on the computer to permit access by the computer system to other computer devices in order to permit the exchange of information with such devices; and computer program instructions stored in either one or both of the primary and secondary memory of the computer system, that permit the processor device to: initiate a user session; and receive a query from a user during a user session, in which a query comprises parameters of requested information comprising the creation of or adjustment to at least one sports betting line associated with one or more specified sporting event participants; and process a query in order to: determine if the user and query are valid; and determine if stored data are sufficient to answer the query, and if so, process said data to satisfy the query; and, if stored data in the secondary memory are insufficient to answer the query or are unavailable, access and organize data available in resources on a computer network to satisfy the query; and compute value, as an adjustment to an existing or specified value; and produce digital output in a manner supporting conveyance of the computed value(s) for the perception of a human user who employs an output device; and monitor for fulfillment of session termination criteria, and if criteria are met, terminate the session; and upon termination by a user of a usage session, termination a user session.

2. The computer system of claim 1, wherein the system produces digital output in a manner supporting conveyance of the value(s) for the automated use of another computer system rather than for the perception of a human user.
